(19) United States
(12) Patent Application Publication
(10) Pub. No.: US 2006/0105812 A1
(43) Pub. Date: May 18, 2006

(54) Apparatus and method for switching operation mode in a dual-mode terminal

(75) Inventor: Young-Wook Shin, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/280,697

(22) Filed: Nov. 16, 2005

(30) Foreign Application Priority Data
Nov. 16, 2004 (KR) 2004-0093401

(51) Int. Cl. H04B 1/38

(52) U.S. Cl. 455/558

(57) ABSTRACT

An apparatus and method for switching a mode in a dual-mode terminal are provided. If the current operation mode is a GSM mode, a CDMA mode key is displayed upon booting of the dual-mode terminal. Upon selection of the CDMA mode key, the operation mode is switched to the CDMA mode. If the current operation mode is the CDMA mode, a GSM mode key is displayed upon booting. Upon selection of the GSM mode key, the operation mode is switched to the GSM mode.

### PRIORITY

This application claims priority under 35 U.S.C. § 119 to an application entitled “Apparatus And Method For Switching Operation Mode In A Dual-Mode Terminal” filed in the Korean Intellectual Property Office on Nov. 16, 2004 and assigned Serial No. 2004-93401, the contents of which are incorporated herein by reference.

### BACKGROUND OF THE INVENTION

1. Field of the Invention

The present invention relates generally to an apparatus and method for switching the operation mode of a dual-mode terminal, and in particular, to an apparatus and method for switching the operation mode of a dual-mode terminal upon booting, without the need for re-booting after switching modes.

2. Description of the Related Art

Due to their portable convenience, the use of mobile phones is explosively growing. The popularity of mobile phones is a driving force behind the development of mobile phones equipped with additional functions at the side of service providers (or terminal manufacturers) in order to attract more users.

Two main mobile communication systems are Global System for Mobile communication (GSM) and Code Division Multiple Access (CDMA). The former works based on TDMA (Time Division Multiple Access), used all over Europe, whereas the latter provides coverage in North America.

A mobile phone configured to operate in one of these two systems works only within the service area of the system. For example, a GSM mobile phone operates only in the GSM network. Therefore, when a CDMA user moves to a GSM service area on business or on a trip, he cannot use his CDMA handset. To relieve the inconvenience, a dual-mode phone using both CDMA and GSM modules has been developed.

In a conventional dual-mode phone, its operation mode is changed using a menu in an idle state after booting. For instance, if a CDMA-GSM dual-mode phone user moves from Europe to the U.S., he turns on his dual-mode phone and, after booting, switches the operation mode through a menu.

The mode switching process of booting the mobile phone and invoking a menu in an idle state takes a lot of time, making it inconvenient.

### SUMMARY OF THE INVENTION

An object of the present invention is to provide an apparatus and method for switching the operation mode of a terminal supporting a plurality of modes, upon booting of the terminal.

Another object of the present invention is to provide an apparatus and method for switching the operation mode of a dual-mode terminal from CDMA to GSM, upon booting of the terminal.

A further object of the present invention is to provide an apparatus and method for switching the operation mode of a dual-mode terminal from GSM to CDMA, upon booting of the terminal.

The above objects are achieved by providing an apparatus and method for switching a mode in a dual-mode terminal.

According to one aspect of the present invention, in a mode switching method in a mobile terminal supporting a plurality of communication modes, it is determined whether a SIM card has been inserted, upon power-on. A plurality of mode transition soft keys are displayed together with a PIN set in the SIM card. Upon user selection of a mode transition soft key, the mobile terminal is switched to a communication mode corresponding to the selected mode transition soft key.

According to another aspect of the present invention, in a method of switching a dual-mode terminal from a GSM mode to a CDMA mode, it is determined whether a SIM card has been inserted, upon power-on. A CDMA mode soft key is displayed together with a personal identification number (PIN) set in the SIM card. Upon user selection of the CDMA mode soft key, the dual-mode terminal is switched to the CDMA mode.

According to a further aspect of the present invention, in a method of switching a dual-mode terminal from a CDMA mode to a GSM mode, it is determined whether a SIM card has been inserted, upon power-on. A GSM mode soft key is displayed together with a PIN set in the SIM card. Upon user selection of the GSM mode soft key, the dual-mode terminal is switched to the GSM mode.

According to still another aspect of the present invention, in an apparatus for switching a dual-mode terminal from a GSM mode to a CDMA mode, a GSM module communicates in the GSM mode and a CDMA module communicates in the CDMA mode. A SIM card stores information about a user. A display displays a CDMA mode soft key together with a personal identification number set in the SIM card, upon booting. A controller deactivates the GSM module and activates the CDMA module, upon selection of the CDMA mode soft key.

According to yet another aspect of the present invention, in an apparatus for switching from a CDMA mode to a GSM mode, a GSM module communicates in the GSM mode and a CDMA module communicates in the CDMA mode. A SIM card stores information about a user. A display displays a GSM mode soft key together with a personal identification number set in the SIM card, upon booting. A controller deactivates the CDMA module and activates the GSM module, upon selection of the GSM mode soft key.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a dual-mode terminal according to the present invention;

FIG. 2 is a flowchart illustrating an operation for switching the operation mode of the dual-mode terminal from GSM to CDMA according to an embodiment of the present invention; and

FIG. 3 is a flowchart illustrating an operation for switching the operation mode of the dual-mode terminal from CDMA to GSM according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

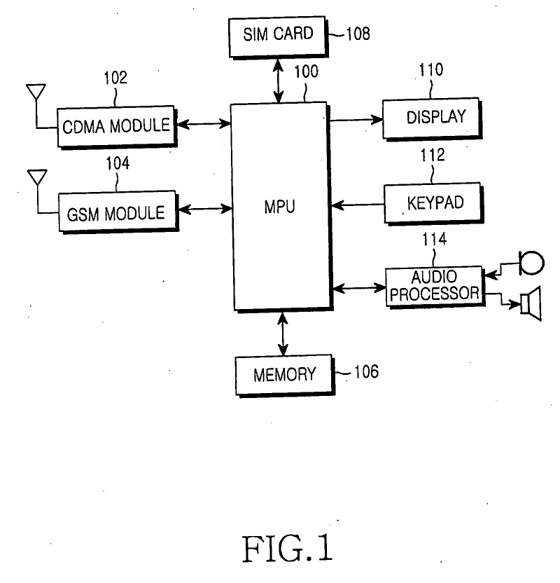

The present invention is intended to provide a technique for switching the operation mode of a dual-mode terminal between CDMA and GSM, as shown in the block diagram of FIG. 1.

Referring to FIG. 1, a micro-processing unit (MPU) 100 provides overall control to the dual-mode terminal. Specifically, the MPU 100 processes and controls voice and data communications, and in addition to this typical functionality, it controls switching of the dual-mode terminal to a user-desired mode, upon booting according to the present invention. Thus, a description of the typical control operation of the MPU 100 will not be provided herein.

A CDMA module 102 includes a radio frequency (RF) processor and a baseband processor. For a reception operation in a CDMA mode, the RF processor downconverts an RF signal received through an antenna to a baseband signal. The baseband processor despreads and channel-decodes the baseband signal. For a transmission operation in the CDMA mode, the baseband processor channel-encodes and spreads transmission data. The RF processor then upconverts the spread baseband signal to an RF signal and transmits the RF signal through the antenna.

A GSM module 104 includes an RF processor and a baseband processor. For a reception operation in a GSM mode, the RF processor downconverts an RF signal received through the antenna to an intermediate frequency (IF) signal. The baseband processor demodulates a baseband signal from the IF signal. For a transmission operation in the GSM mode, the baseband processor modulates transmission data to an IF signal. The RF processor then upconverts the IF signal to an RF signal and transmits the RF signal through the antenna.

A memory 106 includes a read only memory (ROM), a random access memory (RAM), and a flash ROM. The ROM stores the micro-codes of programs needed for processing and controlling in the MPU 100, and reference data. The RAM is a working memory for temporarily storing data generated during execution of the programs. The flash ROM stores updatable data to be kept, such as a phone book, outgoing messages, and incoming messages.

A subscriber identity module (SIM) card 108 is configured to be detachable from the dual-mode terminal. It has a micro-processor and a memory chip in itself and stores information about the user. This SIM card 108 is an essential component for the GSM mode operation of the dual-mode terminal.

A display 110 displays all information processed in the dual-mode terminal. A keypad 112 has digit keys, 0 to 9, and function keys including a Menu key, a Cancel (Clear) key, an OK key, a Talk key, an End key, an Internet key, and navigation keys (directional keys: ▴/▾/ [symbol] / [symbol] ). The keypad 112 provides key input data corresponding to a key pressed by the user to the MPU 100.

An audio processor 114 (called a CODEC) processes input and output of a voice signal through a microphone and a speaker. Specifically, the audio processor 114 converts digital data received form the MPU 100 to an analog voice signal and outputs the analog voice signal through the speaker. Also, it converts a voice signal received from the microphone to digital data and provides the digital data to the MPU 100.

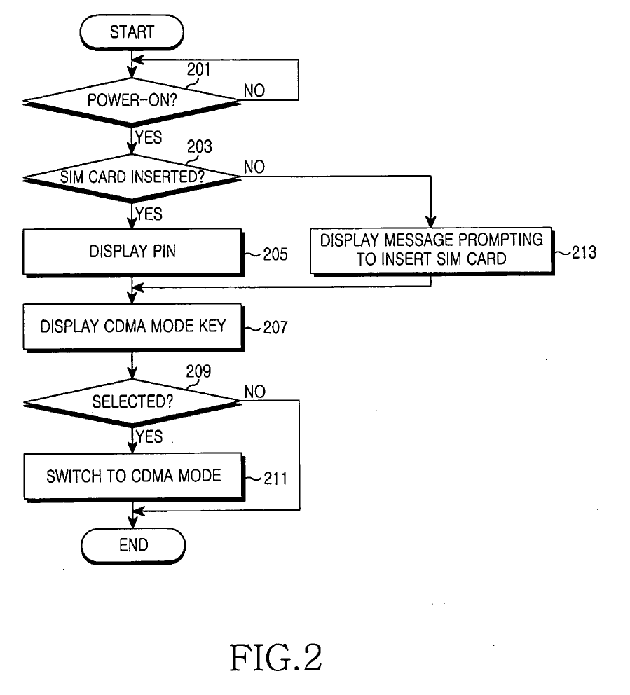

FIG. 2 is a flowchart illustrating an operation for switching the dual-mode terminal from a GSM mode to a CDMA mode according to an embodiment of the present invention.

Referring to FIG. 2, the MPU 100 checks whether power has been supplied to the dual-mode terminal; that is, whether the dual-mode terminal has been booted in step 201. Upon power-on, the MPU 100 determines whether the SIM card 108, being a detachable smart card, has been inserted into the dual-mode terminal in step 203.

In the absence of the SIM card 108, the MPU 100 displays a message prompting the user to insert the SIM card 108 in step 213 and proceeds to step 207. On the other hand, in the presence of the SIM card 108, the MPU 100 displays a personal identification number (PIN) set in the SIM card 108 through the display 110 to allow the user to check the PIN in step 205.

In step 207, the MPU 100 displays a CDMA mode key together with the PIN or the message requesting insertion of the SIM card 108. The MPU 100 determines whether the CDMA mode key has been selected in step 209. If the CDMA mode key is not selected, the MPU 100 ends the procedure.

Upon selection of the CDMA mode key, the MPU 100 switches the dual-mode terminal from the current GSM mode to the CDMA mode in step 211 and then terminates the procedure.

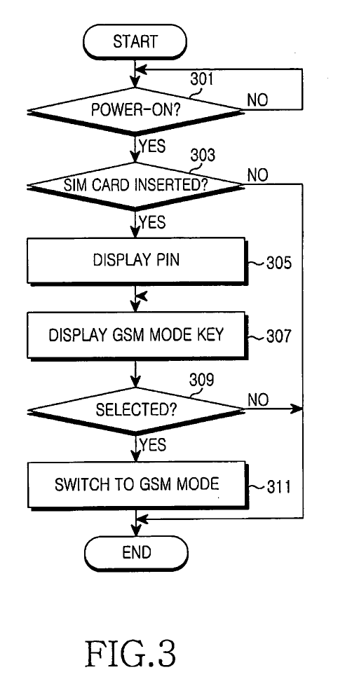

FIG. 3 is a flowchart illustrating an operation for switching the dual-mode terminal from the CDMA mode to the GSM mode according to an embodiment of the present invention.

Referring to FIG. 3, the MPU 100 supplies power to the dual-mode terminal, that is, it boots the dual-mode terminal in step 301. The MPU 100 then determines whether the SIM card 108 has been inserted into the dual-mode terminal in step 303. In the absence of the SIM card 108, the MPU 100 terminates the procedure because a PIN check is needed for transition to the GSM mode.

In the presence of the SIM card 108, the MPU 100 displays a PIN set in the SIM card 108 through the display 110 in step 305. In step 307, the MPU 100 displays a GSM mode key together with the PIN.

The MPU 100 determines whether the GSM mode key has been selected in step 309. If the GSM mode key is not selected, the MPU 100 ends the procedure. Upon selection of the GSM mode key, the MPU 100 switches the dual-mode terminal from the current CDMA mode to the GSM mode in step 311 and then terminates the procedure.

While a mode switching occurs between the GSM mode and the CDMA mode upon booting of the GSM-CDMA dual-mode terminal in the above embodiment of the present invention, it can be further contemplated as another embodiment that a user-desired mode can be transitioned to upon booting of a mobile phone supporting a plurality of communication modes (i.e. operation modes). For example, the communication modes include Wideband Code Division Multiple Access (WCDMA), Code Division Multiple Access 2000 (CDMA 2000), High Speed Downlink Packet Access (HSDPA), 1× EVolution-Data Only (1× EV-DO), and 1× EVolution-Data and Voice (1× EV-DV).

As described above, the present invention advantageously switches the operation mode of a dual-mode terminal without re-booting. Since mode switching is carried out by means of a predetermined soft key upon booting of the terminal, it obviates the need for mode switching in an idle state, accompanied by re-booting.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mode switching method in a mobile terminal supporting a plurality of communication modes, comprising the steps of:
determining whether a subscriber identity module (SIM) card has been inserted, upon power-on;
displaying a plurality of mode transition soft keys together with a personal identification number (PIN) set in the SIM card; and
switching, upon user selection of a mode transition soft key, the mobile terminal to a communication mode corresponding to the selected mode transition soft key.

2. The mode switching method of claim 1, further comprising displaying the mode transition soft key together with a message prompting a user to insert the SIM card, in the absence of the SIM card.

3. A method of switching a dual-mode terminal from a Global System for Mobile communication (GSM) mode to a Code Division Multiple Access (CDMA) mode, comprising the steps of:
determining whether a subscriber identity module (SIM) card has been inserted, upon power-on;
displaying a CDMA mode soft key together with a personal identification number (PIN) set in the SIM card; and
switching, upon user selection of the CDMA mode soft key, the dual-mode terminal to the CDMA mode.

4. The method of claim 3, further comprising displaying the CDMA mode soft key together with a message prompting a user to insert the SIM card, in the absence of the SIM card.

5. A method of switching a dual-mode terminal from a Code Division Multiple Access (CDMA) mode to a Global System for Mobile communication (GSM) mode, comprising the steps of:
determining whether a subscriber identity module (SIM) card has been inserted, upon power-on;
displaying a GSM mode soft key together with a personal identification number (PIN) set in the SIM card; and
switching, upon user selection of the GSM mode soft key, the dual-mode terminal to the GSM mode.

6. The method of claim 5, further comprising displaying the GSM mode soft key together with a message prompting a user to insert the SIM card, in the absence of the SIM card.

7. A mode switching method in a mobile terminal supporting a plurality of communication modes, comprising the steps of:
identifying whether a subscriber identity module (SIM) card has been inserted in the mobile terminal;
displaying a plurality of mode transition soft keys;
displaying a personal identification number (PIN) set in the SIM card; and
switching the mobile terminal to a communication mode corresponding to the selected mode transition soft key.

8. The mode switching method of claim 7, further comprising instructing a user to insert the SIM card when the absence of the SIM card is identified, before displaying the plurality of mode transition soft keys.

9. A method of switching a dual-mode terminal from a Global System for Mobile communication (GSM) mode to a Code Division Multiple Access (CDMA) mode, comprising the steps of:
identifying whether a subscriber identity module (SIM) card has been inserted in the mobile terminal;
displaying a CDMA mode soft key;
displaying a personal identification number (PIN) set in the SIM card; and
switching the dual-mode terminal to the CDMA mode.

10. The method of claim 9, further comprising instructing a user to insert the SIM card when the absence of the SIM card is identified before displaying the CDMA mode soft key.

11. A method of switching a dual-mode terminal from a Code Division Multiple Access (CDMA) mode to a Global System for Mobile communication (GSM) mode, comprising the steps of:
identifying whether a subscriber identity module (SIM) card has been inserted;
displaying a GSM mode soft key;
displaying a personal identification number (PIN) set in the SIM card; and
switching the dual-mode terminal to the GSM mode.

12. The method of claim 11, further comprising instructing a user to insert the SIM card when the absence of the SIM card is identified before displaying the GSM mode soft key.

13. An apparatus for switching a dual-mode terminal from a Global System for Mobile communication (GSM) mode to a Code Division Multiple Access (CDMA) mode, comprising:
a GSM module for communicating in the GSM mode;
a CDMA module for communicating in the CDMA mode;
a subscriber identity module (SIM) card for storing information about a user;
a display for displaying a CDMA mode soft key together with a personal identification number set in the SIM card, upon booting; and
a controller for deactivating the GSM module and activating the CDMA module, upon selection of the CDMA mode soft key.

14. The apparatus of claim 13, wherein the display displays the CDMA mode soft key together with a message prompting the user to insert the SIM card, in the absence of the SIM card upon booting.

15. An apparatus for switching from a Code Division Multiple Access (CDMA) mode to a Global System for Mobile communication (GSM) mode, comprising:
a GSM module for communicating in the GSM mode;
a CDMA module for communicating in the CDMA mode;
a subscriber identity module (SIM) card for storing information about a user;
a display for displaying a GSM mode soft key together with a personal identification number set in the SIM card, upon booting; and
a controller for deactivating the CDMA module and activating the GSM module, upon selection of the GSM mode soft key.

16. The apparatus of claim 15, wherein the display displays the GSM mode soft key together with a message prompting the user to insert the SIM card, in the absence of the SIM card upon booting.

17. An apparatus for switching a dual-mode terminal from a first mode to a second mode, comprising:
a first mode module for communicating in the first mode;
a second mode module for communicating in the second mode;
a subscriber identity module (SIM) card for storing information about a user;
a display for displaying a second mode soft key together with a personal identification number set in the SIM card, upon booting; and
a controller for deactivating the first mode module and activating the second mode module, upon selection of the second mode soft key.
